(19) United States
(12) Patent Application Publication
(10) Pub. No.: US 2017/0021877 A1
(43) Pub. Date: Jan. 26, 2017

(54) Kingpin Locking System

(71) Applicant: Wesley Drumgold, Bronx, NY (US)

(72) Inventor: Wesley Drumgold, Bronx, NY (US)

(21) Appl. No.: 15/051,192

(22) Filed: Feb. 23, 2016

Related U.S. Application Data
(60) Provisional application No. 62/119,500, filed on Feb. 23, 2015.

(51) Int. Cl. B62D 53/08; E05B 73/00

(52) U.S. Cl. CPC B62D 53/085; E05B 73/00

(57) ABSTRACT

A kingpin locking system for securing a kingpin on a trailer to a tractor is provided. The system comprises a C-shaped member having a main body portion, a first jaw portion, and a second jaw portion. A first spring member is mounted between the center portion and the first jaw portion with the first spring member allowing the first jaw portion to move in a general direction toward and away from the second jaw portion. A key mechanism activates a locking mechanism to lock the first and second jaw portions together and deactivates the locking mechanism to unlock the first and second jaw portions. Upon positioning the C-shaped member about the kingpin and moving the first jaw portion into contact with the second jaw portion, the key mechanism activates the locking mechanism thereby securing the first and second jaw portion together and securing the trailer to the tractor.

### CLAIM OF PRIORITY

This patent application claims priority under 35 USC 119 (e) (1) from U.S. Provisional Patent Application Ser. No. 62/119,500 filed Feb. 23, 2015, of common inventorship herewith entitled, “King Lock,” which is incorporated herein by reference as though the same were set forth in its entirety.

### FIELD OF THE INVENTION

The present invention pertains to the field of steel locks, and more specifically to the field of tools for securing trucks and tractor trailers.

### BACKGROUND OF THE INVENTION

Millions of professional truckers head off across the highways and byways of this great land every day, transporting goods and products to the American consumer populace. Whether a local produce man delivering fresh milk and eggs to the neighborhood grocer, a commercial mover transporting a family's belongings across the state, or a long haul driver delivering medical supplies to hospitals across the country, the trucking industry and professional truck drivers are crucial members of society, delivering the food, goods and supplies needed by people from all walks of life.

Unfortunately for truckers, there is one problem which may impede their ability to deliver goods. Specifically, cargo theft is a serious problem endured by professionals in all aspects of the trucking industry. Industry experts estimate that last year alone, truckloads carrying approximately four hundred eighty seven million dollars' worth of goods were stolen, nearly double the rate stolen the year before. Savvy criminals will follow a truck all the way from the plant where goods are manufactured or packed, as well as wait at truck stops and cargo bays in the hopes that a trucker will leave their rig unattended for a few minutes to grab a bite to eat or take a quick shower. The thieves then will hitch the unattended trailer to another tractor, driving the trailer away before the trucker even knows their trailer is missing. Often when a truck is hijacked in this manner, the tractor is left at the site of the theft, while the empty trailer is found miles away, abandoned and sometimes repainted to disguise the trailer. The theft of a trailer can cost a trucking company hundreds of thousands of dollars and result in a truck driver losing his contract and enduring undo stress.

The prior art has put forth several designs for tools for securing trucks and tractor trailers. Among these are:

U.S. Pat. No. 2,785,564 to Carrato Rossi relates to trailer hitches of semitrailers of the type hauled by tractors, and more particularly to a lock for application to a hitch pin to prevent unauthorized or inadvertent engagement of the hitch pin by the fifth wheel of a tractor. In freight distribution centers, it is a common practice to park a substantial number of semitrailers at a loading platform. After trailers are loaded, the tractors are engaged with the respective trailers for hauling to their destination. It sometimes happens that the driver of a tractor fails to properly identify the trailer, and as a result, picks up the wrong trailer and hauls it to the wrong destination. A great deal of time and money is spent in locating the misplaced trailer and correcting the error. It sometimes occurs that an unauthorized person having a standard tractor, picks up a trailer and hauls it away. The present invention eliminates these drawbacks, occasioned by the uniform construction of the trailer hitching pin and the tractor fifth wheels, by providing a lock for the hitch pin which effectively prevents engagement of the fifth wheel with the hitch pin by unauthorized or mistaken tractor operators. When the trailer is parked, the hitching pin is locked, and thereafter only the tractor driver having the proper key can pick up the trailer without breaking the lock.

U.S. Pat. No. 2,706,392 to Ralph S. Chaffin, William D. Edwards and Guy L. Lucas describes a lock collar which fits onto a kingpin or similar member of a conventional freight trailer to prevent such kingpin from being positioned in unauthorized engagement with the jaws of a fifth wheel or other engaging means of a tractor, such as would be used in moving the trailer. The coupling between freight pulling tractors and trailers is standardized so that any tractor can be coupled to any trailer throughout the trucking industry and these couplings include the use of a so called fifth wheel mounted on a tractor which engages with a kingpin extending downwardly from the frame of the trailer to couple the trailer to the tractor to be moved thereby. The kingpins normally have a recess therein to aid in coupling the kingpin to a tractor. Trailers are frequently parked or stored at isolated spots are temporarily stored in any of a number of places where the owner of the trailer is unable to watch them. It becomes necessary to take some type of preventive action to prevent unauthorized use or theft of trailers, and the lock collar of this invention is constructed for such purpose. The general object of this invention is to provide a novel lock collar for a trailer kingpin in which the lock collar is characterized by its generally tubular construction and by a minimum of movable parts provided in the lock collar. The lock collar of the invention broadly comprises a two section circumferentially split tubular member having a bore for engaging a trailer kingpin. This tubular member may have one partially closed end for abutting the outer end of a kingpin when the lock collar is engaged therewith, and means are provided for securing the sections of the tubular member permanently together.

U.S. Pat. No. 2,641,124 to Samuel D. Gallagher and John Lamversie describes a means for preventing thefts of parked trailer trucks by housing a free king pin in a sleeve which is secured to the pin against unauthorized removal by a lock encased on the sleeve in such a manner that it is impossible to remove the lock without causing damage to the pin and rendering said pin unfit for use. This invention provides a means for rendering the usual king pin of a trailer truck immune to the interconnection with the fifth wheel of an unauthorized tractor. When released from the fifth wheel of a lawful tractor, said pin is completely housed by a cylindrical sleeve in such a manner that when the upper end of the sleeve abuts the under face of the upper fifth wheel plate, the sliding U shaped shackle of a padlock is insertable through an opening in the side wall of the sleeve to be received by the usual annular slot in the king pin. The padlock and bight portion of the shackle are enclosed within the casings on the sleeve to prevent the application of a tool for cutting the shackle from the lock.

None of these prior art references describe the present invention.

### SUMMARY OF THE INVENTION

It is an object of the present invention to provide a hardened steel lock that is installable around a kingpin to functionally secure a trailer to a truck tractor.

The present invention is a kingpin locking system for securing a trailer to a tractor. The trailer has a kingpin receivable by the tractor. The kingpin locking system comprises a C-shaped member having a main body portion, a first jaw portion, and a second jaw portion with the main body portion having a first end and a second end, the first jaw portion having a first proximal end and a first distal end, and the second jaw portion having a second proximal end and a second distal end. A first spring member is mounted between the first end of the center portion and the first proximal end of the first jaw portion with the first spring member allowing the first distal end the first jaw portion to move in a general direction toward and away from the second distal end of the second jaw portion. A locking mechanism is associated with the first distal end of the first jaw portion and the second distal end of the second jaw portion. A key mechanism activates the locking mechanism to lock the first jaw portion to the second jaw portion and deactivates the locking mechanism to unlock the first jaw portion from the second jaw portion. Upon positioning the C-shaped member about the kingpin and moving the first distal end of the first jaw portion into contact with the second distal end of the second jaw portion, the key means is capable of activating the locking mechanism thereby securing the first distal end of the first jaw portion to the second distal end of the second jaw portion and securing the trailer to the tractor.

In addition, the present invention includes a method for securing a trailer to a tractor. The trailer has a kingpin receivable by the tractor. The method comprises providing a C-shaped member having a main body portion, a first jaw portion, and a second jaw portion with the main body portion having a first end and a second end, the first jaw portion having a first proximal end and a first distal end, and the second jaw portion having a second proximal end and a second distal end, mounting a first spring member between the first end of the center portion and the first proximal end of the first jaw portion, moving the first distal end the first jaw portion in a general direction toward and away from the second distal end of the second jaw portion, associating a locking mechanism with the first distal end of the first jaw portion and the second distal end of the second jaw portion, positioning the C-shaped member about the kingpin, moving the first distal end of the first jaw portion into contact with the second distal end of the second jaw portion, and activating the locking mechanism to lock the first jaw portion to the second jaw portion thereby securing the first distal end of the first jaw portion to the second distal end of the second jaw portion and securing the trailer to the tractor.

The present invention further includes a kingpin locking system for securing a trailer to a tractor. The trailer has a kingpin receivable by the tractor. The kingpin locking system comprises a C-shaped member having a center portion, a first jaw portion, and a second jaw portion with the center portion having a first end and a second end, the first jaw portion having a first proximal end and a first distal end, and the second jaw portion having a second proximal end and a second distal end. A first spring member is mounted between the first end of the center portion and the first proximal end of the first jaw portion with the first spring member biasing the first jaw portion in a general direction away from the center portion and allowing the first distal end of the first jaw portion to move in a general direction toward and away from second distal end of the second jaw portion. A second spring member is mounted between the second end of the center portion and the second proximal end of the second jaw portion with the second spring member biasing the second jaw portion in a general direction away from the center portion and allowing the second distal end of the second jaw portion to move in a general direction toward and away from the first distal end of the first jaw portion. A locking mechanism is associated with the first distal end of the first jaw portion and the second distal end of the second jaw portion. A key mechanism activates the locking mechanism to lock the first jaw portion to the second jaw portion and deactivates the locking mechanism to unlock the first jaw portion from the second jaw portion. Upon positioning the C-shaped member about the kingpin and moving the first distal end of the first jaw portion into contact with the second distal end of the second jaw portion, the key mechanism is capable of activating the locking mechanism thereby securing the first distal end of the first jaw portion to the second distal end of the second jaw portion and securing the trailer to the tractor.

### BRIEF DESCRIPTION OF THE DRAWINGS

FIG. 1 is an elevational side view illustrating a trailer having a kingpin for use with a kingpin locking system, constructed in accordance with the present invention.

FIG. 2 is a perspective view illustrating the kingpin locking system constructed in accordance with the present invention, with an X shaped key lock and integrated springs allowing easy opening and closing of the present invention.

FIG. 3 is a perspective view illustrating the kingpin locking system constructed in accordance with the present invention installed on a kingpin located beneath the front end of a tractor trailer.

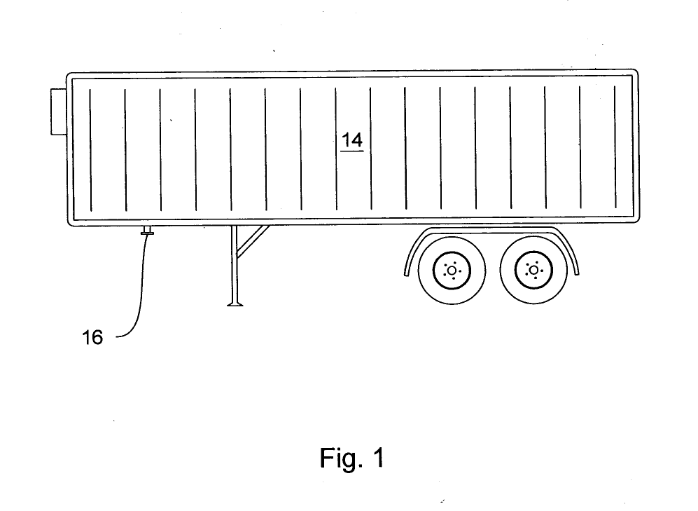

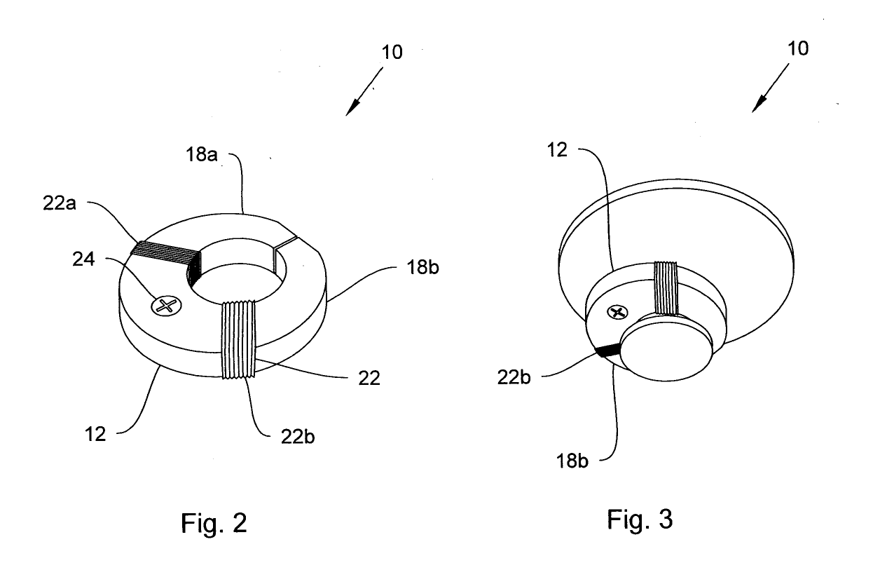

### DETAILED DESCRIPTION OF THE INVENTION

The present invention, hereinafter referred to as a Kingpin Locking System, indicated generally at 10, is a hardened steel lock that is installed around a kingpin 16 and secures a trailer 14 to a truck's tractor. The Kingpin Locking System 10 provides professionals in the trucking industry with a practical tool which readily prevents an increasingly common problem of cargo theft by effectively preventing thieves from releasing a trailer 14 from an existing tractor and hauling it away. A kingpin 16 is a heavy metal cylindrical pin that is located beneath a front end of a trailer 14 and functionally connects the trailer 14 to the road tractor. The lock 12 of the Kingpin Locking System 10 of the present invention is configured to clamp around the installed kingpin 16.

The Kingpin Locking System 10 of the present invention is a C-shaped lock 12 comprised of two, heavy duty spring loaded jaws 18, i.e., a first jaw portion 18a and a second jaw portion 18b, connected to a center portion 20 by at least one spring member 22. The jaws 18 curve around the kingpin 16 and come are joined together on the opposite side so the present invention encircles the kingpin 16 entirely. In a preferred embodiment, there are two spring members 22, i.e., a first spring member 22a and a second spring member 22b.

With the Kingpin Locking System 10 of the present invention, the aforementioned jaws 18 are configured to interlock together when applied about the kingpin 16. An integrated heavy duty safety key lock 24 has a dedicated and unique key for use in securing the lock 12 present invention in place about the kingpin 16.

Universal in configuration to accommodate virtually any kingpin 16 from any manufacturer, the lock 12 of the Kingpin Locking System 10 of the present invention measures approximately one foot to one and one half feet in diameter and six inches in depth. This reliable lock 12 is preferably manufactured in polished metal tones as well as hues of red, black or blue.

Application and use of the lock 12 of the Kingpin Locking System 10 of the present invention is simple and straight forward. After joining a trailer to one's tractor by connecting the two components together utilizing the trailer's kingpin 16, the professional trucker then employs the lock 12 on the existing kingpin 16. Opening the jaws 18 of the lock 12, the user positions the lock 12 around the kingpin 16, clamping the two interlocking jaws 18 together to encircle the kingpin 16 completely. A locking mechanism associated with the jaws 18 locks the jaws 18 together. The user then utilizes the unique key lock 24 to lock the lock 12 in place. As understood by those persons skilled in the art, appropriate linkage between the key lock 24 and the locking mechanism can accomplish the locking and unlocking action of the locking mechanism. The key lock 24 can also be a combination lock, depending the needs and desires of the users and the manufacturers.

The lock 12 of the Kingpin Locking System 10 of the present invention remains on the kingpin 16 throughout the trucker's journey, providing an impenetrable barrier that prevents thieves from releasing the trailer 14 and stealing contained cargo. Upon arriving at their delivery destination, the trucker utilizes the dedicated key to open the lock 12 and release the kingpin 16 and trailer 14 from the tractor cab. This process is repeated with every load transported. The present invention is compact and easily storable within a truck's cab or other easily accessed area.

The Kingpin Locking System 10 of the present invention provides an impenetrable barrier which effectively deters criminals from attempting to steal a trailer and contained goods. Using the Kingpin Locking System 10 reduces a time consuming hassle of dealing with ramifications of stolen cargo such as filling out extensive paper work, filing police reports and insurance claims. Installation of the Kingpin Locking System 10 ensures that goods are delivered to their specified destinations on time and in a sound manner. Professional truckers can rest easy on overnight stops or when taking a break at truck stops for refueling or much needed rest. Ensuring that items stored within the cargo trailer are secure, using the Kingpin Locking System 10 of the present invention reduces insurance costs and results in happier satisfied customers. Extremely simple to use and durably constructed, this sturdy lock will withstand years of continued use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claim.

1. A kingpin locking system for securing a trailer to a tractor, the trailer having a kingpin receivable by the tractor, the kingpin locking system comprising:
a C-shaped member having a main body portion, a first jaw portion, and a second jaw portion, the main body portion having a first end and a second end, the first jaw portion having a first proximal end and a first distal end, and the second jaw portion having a second proximal end and a second distal end;
a first spring member mounted between the first end of the center portion and the first proximal end of the first jaw portion, the first spring member allowing the first distal end the first jaw portion to move in a general direction toward and away from the second distal end of the second jaw portion;
a locking mechanism associated with the first distal end of the first jaw portion and the second distal end of the second jaw portion; and
key means for activating the locking mechanism to lock the first jaw portion to the second jaw portion and for deactivating the locking mechanism to unlock the first jaw portion from the second jaw portion;
wherein upon positioning the C-shaped member about the kingpin and moving the first distal end of the first jaw portion into contact with the second distal end of the second jaw portion, the key means is capable of activating the locking mechanism thereby securing the first distal end of the first jaw portion to the second distal end of the second jaw portion and securing the trailer to the tractor.

2. The kingpin locking system of claim 1 wherein the first spring member biases the first jaw portion in a general direction away from the center portion.

3. The kingpin locking system of claim 1 and further comprising:
a second spring member mounted between the second end of the center portion and the second proximal end of the second jaw portion, the second spring member allowing the second distal end of the second jaw portion to move in a general direction toward and away from the first distal end of the first jaw portion.

4. The kingpin locking system of claim 3 wherein the second spring member biases the second jaw portion in a general direction away from the center portion.

5. The kingpin locking system of claim 1 wherein the C-shaped member is capable of completely encircling the kingpin.

6. The kingpin locking system of claim 1 wherein the key means is a key hole positioned in the approximate center of the center portion.

7. The kingpin locking system of claim 6 wherein the key hole is capable of receiving a key, the key rotatable to activate and deactivate the locking, mechanism.

8. The kingpin locking system of claim 1 wherein the key means is a combination key, wherein upon entering a designated combination, the locking mechanism is deactivated.

9. The kingpin locking system of claim 1 and further comprising:
linkage between the key means and the locking mechanism allowing the key means to operate the locking mechanism.

10. The kingpin locking system of claim 1 wherein the C-shaped member measures approximately one foot to one and one half feet in diameter and six inches in depth.

11. A method for securing a trailer to a tractor, the trailer having a kingpin receivable by the tractor, the method comprising:
providing a C-shaped member having a main body portion, a first jaw portion, and a second jaw portion, the main body portion having a first end and a second end, the first jaw portion having a first proximal end and a first distal end, and the second jaw portion having a second proximal end and a second distal end;
mounting a first spring member between the first end of the center portion and the first proximal end of the first jaw portion;
moving the first distal end the first jaw portion in a general direction toward and away from the second distal end of the second jaw portion;
associating a locking mechanism with the first distal end of the first jaw portion and the second distal end of the second jaw portion;
positioning the C-shaped member about the kingpin;
moving the first distal end of the first jaw portion into contact with the second distal end of the second jaw portion; and
activating the locking mechanism to lock the first jaw portion to the second jaw portion thereby securing the first distal end of the first jaw portion to the second distal end of the second jaw portion and securing the trailer to the tractor.

12. The method of claim 11 and further comprising:
biasing the first jaw portion in a general direction away from the center portion.

13. The method of claim 11 and further comprising:
mounting a second spring member between the second end of the center portion and the second proximal end of the second jaw portion; and
moving the second distal end of the second jaw portion in a general direction toward and away from the first distal end of the first jaw portion.

14. The method of claim 13 and further comprising:
biasing the second jaw portion in a general direction away from the center portion.

15. The method of claim 11 and further comprising:
completely encircling the kingpin with the C-shaped member.

16. The method of claim 11 and further comprising:
positioning a key hole in the approximate center of the center portion.

17. The kingpin locking system of claim 16 wherein the key hole is capable of receiving a key, and further comprising:
rotating the key to activate and deactivate the locking mechanism.

18. The method of claim 11 and further comprising:
providing a combination key;
entering a designated combination; and
deactivating the locking mechanism.

19. The method of claim 11 and further comprising:
providing linkage between the key means and the locking mechanism allowing the key means to operate the locking mechanism.

20. A kingpin locking system for securing a trailer to a tractor, the trailer having a kingpin receivable by the tractor, the kingpin locking system comprising:
a C-shaped member having a center portion, a first jaw portion, and a second jaw portion, the center portion having a first end and a second end, the first jaw portion having a first proximal end and a first distal end, and the second jaw portion having a second proximal end and a second distal end;
a first spring member mounted between the first end of the center portion and the first proximal end of the first jaw portion, the first spring member biasing the first jaw portion in a general direction away from the center portion and allowing the first distal end of the first jaw portion to move in a general direction toward and away from second distal end of the second jaw portion;
a second spring member mounted between the second end of the center portion and the second proximal end of the second jaw portion, the second spring member biasing the second jaw portion in a general direction away from the center portion and allowing the second distal end of the second jaw portion to move in a general direction toward and away from the first distal end of the first jaw portion;
a locking mechanism associated with the first distal end of the first jaw portion and the second distal end of the second jaw portion; and
key means for activating the locking mechanism to lock the first jaw portion to the second jaw portion and for deactivating the locking mechanism to unlock the first jaw portion from the second jaw portion;
wherein upon positioning the C-shaped member about the kingpin and moving the first distal end of the first jaw portion into contact with the second distal end of the second jaw portion, the key means is capable of activating the locking mechanism thereby securing the first distal end of the first jaw portion to the second distal end of the second jaw portion and securing the trailer to the tractor.
